(19) United States
(12) Patent Application Publication
(10) Pub. No.: US 2010/0099012 A1
(43) Pub. Date: Apr. 22, 2010

(54) Electrocatalyst Synthesized by Depositing a Contiguous Metal Adlayer on Transition Metal Nanostructures

(75) Inventor: Radoslav Adzic, East Setauket, NY (US)

Correspondence Address: BROOKHAVEN SCIENCE ASSOCIATES/;BROOKHAVEN NATIONAL LABORATORY, BLDG. 490C - P.O. BOX 5000, UPTON, NY, 11973, US

(73) Assignee: Brookhaven Science Associates, LLC, Upton, NY (US)

(21) Appl. No.: 12/581,430

(22) Filed: Oct. 19, 2009

Related U.S. Application Data
(60) Provisional application No. 61/106,359, filed on Oct. 17, 2008.

(51) Int. Cl. H01M 4/00; B01J 23/44; B01J 23/42; B01J 23/745; B01J 23/75; B01J 23/755; B01J 23/20; B01J 23/30; B01J 23/52

(52) U.S. Cl. 429/44; 502/339; 502/337; 502/338; 502/325; 502/350; 502/353; 502/305; 502/344; 502/313; 502/317

(57) ABSTRACT

Transition metal nanostructures coated with a contiguous, conformal submonolayer-to-multilayer noble metal film and their method of manufacture are described. The manufacturing process involves the initial formation of suitably sized transition metal or alloy nanostructures which may be nanorods, nanobars, or nanowires. A monolayer of a non-noble metal is deposited onto the surface of the nanostructures by underpotential deposition. This is followed by the galvanic displacement of the non-noble metal by a second metal to yield a conformal coating of a monolayer of the second metal on the surface of the nanostructures. The replacement of atoms of the first metal by atoms of the second metal is an irreversible and spontaneous redox reaction which involves the replacement of a non noble metal by a more noble metal. The process can be controlled and repeated to obtain the desired film coverage. The resulting coated nanostructures provide heightened catalytic activity and can be used as high-performance electrodes in fuel cells.

### CROSS-REFERENCE TO RELATED APPLICATION

This application claims the benefit of U.S. Provisional Application No. 61/106,359, filed Oct. 17, 2008, which is incorporated herein by reference in its entirety.

### STATEMENT OF GOVERNMENT LICENSE RIGHTS

The present invention was made with government support under Grant No. DE-AC02-98CH10886, awarded by the U.S. Department of Energy. The United States government has certain rights in the invention.

### BACKGROUND OF THE INVENTION

I. Field of the Invention

This invention relates generally to the field of electrochemical conversion devices. In particular, the present invention relates to the controlled deposition of conformal thin films of platinum on interconnected high-surface-area transition metal nanostructures. The invention also relates to the utilization of these nanostructures as oxygen-reduction electrocatalysts in fuel cells.

II. Background of the Related Art

A fuel cell is an electrochemical device capable of converting the chemical energy of a fuel and an oxidant into electrical energy. The energy conversion process is analogous to the basic principles governing operation of an electrochemical battery, but with some notable exceptions. A battery is a closed system with a finite amount of stored chemical energy whereas a fuel cell consumes the reactants and is capable of continuous operation. As long as the requisite fuel and oxidant are provided a fuel cell can, in theory, produce electrical energy indefinitely.

A standard fuel cell is comprised of an anode and cathode separated by a conducting electrolyte which electrically insulates the electrodes yet permits the flow of ions between them. The fuel cell operates by separating electrons and ions from the fuel at the anode and transporting the electrons through an external circuit to the cathode. The ions are concurrently transported through the electrolyte to the cathode where the oxidant is combined with the ions and electrons to form a waste product. An electrical circuit is therefore completed by the concomitant flow of ions from the anode to cathode via the conducting electrolyte and the flow of electrons from the anode to the cathode via the external circuit.

The science and technology of fuel cells has received considerable attention, being the subject of numerous books and journal articles including, for example, “Handbook of Fuel Cells Fundamentals, Technology, Applications,” edited by W. Vielstich, A. Lamm, and H. A. Gasteiger, Hoboken, N.J.: J. Wiley & Sons (2003). Although there are various types of fuels and oxidants which may be used, the most significant is the H₂—O₂ system. In a hydrogen-oxygen fuel cell, hydrogen (H₂) is supplied to the anode as the fuel where it dissociates into H⁺ ions and provides electrons to the external circuit. Oxygen (O₂) supplied to the cathode undergoes a reduction reaction in which O₂ combines with electrons from the external circuit and ions in the electrolyte to form H₂O as a byproduct. The overall reaction pathways leading to oxidation at the anode and reduction at the cathode are strongly dependent on the materials used as the electrodes and the type of electrolyte.

Under standard operating conditions the H₂ and O₂ oxidation/reduction reactions proceed very slowly, if at all, requiring elevated temperatures and/or high electrode potentials to proceed. Reaction kinetics at the electrodes may be accelerated by the use of metals such as platinum (Pt), palladium (Pd), ruthenium (Ru), and related alloys. Electrodes formed of these materials function as electrocatalysts since they accelerate electrochemical reactions at electrode surfaces yet are not themselves consumed by the overall reaction. Despite the significant performance improvements attainable with electrocatalysts, successful commercialization of fuel cells requires still further increases in performance and cost efficiency.

Pt has been shown to be one of the best electrocatalysts, but its successful implementation in commercially available fuel cells is hindered by its high cost, susceptibility to carbon monoxide (CO) poisoning, poor stability under cyclic loading, and the relatively slow kinetics of O₂ reduction at the cathode. A variety of approaches have been employed in attempting to solve these problems. An example is U.S. Pat. No. 6,232,264 to Lukehart, et al. which discloses polymetallic nanoparticles such as platinum-palladium alloy nanoparticles for use as fuel cell electrocatalysts. Another example is U.S. Pat. No. 6,670,301 to Adzic, et al. which discloses a process for depositing a thin film of Pt on dispersed Ru nanoparticles supported on carbon (C) substrates. These approaches have resulted in electrocatalysts with reduced Pt loading and a higher tolerance for CO poisoning.

While significant progress has been made towards understanding the complex kinetics of oxygen reduction, a detailed atomic-level understanding of the reaction pathways resulting in oxygen reduction on Pt surfaces has not yet emerged (see, for example, R. Adzic, “Recent Advances in the Kinetics of Oxygen Reduction,” Electrocatalysis, pp. 197-242 (1998)). As a result, attempts to accelerate the oxidation reduction reaction (ORR) on Pt while simultaneously reducing Pt loading have been met with limited success. Recent approaches have utilized high surface area Pt or Pd nanoparticles supported by nanostructured carbon (Pt/C or Pd/C) as described, for example, in U.S. Pat. No. 6,815,391 to Xing, et al, the entire contents of which is incorporated by reference as if fully set forth in this specification. However, as an oxygen reduction catalyst, bulk Pt is still several times more active than Pt/C and Pd/C nanoparticle electrocatalysts.

### SUMMARY OF THE INVENTION

In view of these and other considerations, there is a need to develop an electrocatalyst which minimizes Pt loading while simultaneously maximizing the available catalytically active Pt surface area and improving oxidation reduction reaction (ORR) kinetics. In some embodiments, the invention provides a cost-effective fuel cell with improved efficiency and stability by utilizing an improved Pt-based electrocatalyst as the cathode. In one embodiment this is accomplished by a method involving the controlled deposition of contiguous conformal thin metal films onto high-surface-area transition metal nanostructures. Such coated nanostructures facilitate more efficient and cost-effective electrochemical energy conversion in fuel cells, metal-air batteries, and during corrosion processes.

In one embodiment, an electrocatalyst comprises a nanostructured core of a transition metal covered with a contiguous adlayer of a noble metal. The transition metal core preferentially comprises Pd which is covered with an adlayer of Pt. The transition metal nanostructures are preferentially shaped into nanobars, nanorods, or nanowires. The coated nanostructures are formed by a method comprising initially fabricating a substrate having a plurality of transition metal nanostructures. A continuous adlayer of a non-noble metal such as copper (Cu) is then formed on the surface of the nano structures by underpotential deposition (UPD). Immersing the nanostructures in a salt comprising a noble metal results in replacement of the non-noble metal by the noble metal. The method preferentially forms Pd nanobars, nanorods, or nanowires which are conformally coated with a thin layer of Pt atoms.

In another embodiment, thin film deposition proceeds by the redox displacement of an adlayer of a non-noble metal by a more noble metal. This enables the controlled deposition of a thin, contiguous layer of a desired metal onto a substrate. The substrate itself is comprised of high-surface-area nanostructures which are continuously interconnected. The coated metal/substrate nanostructured substrate provides a large, continuous surface area of the metal or surface reactions while minimizing the amount of the metal required. This configuration also benefits from synergistic effects which are possible with various combinations of metal films and nanostructured substrates. This includes obtaining surface reaction rates higher than the properties of substrates fabricated from a bulk material of either the metal or the substrate alone.

In a preferred embodiment the metal is a monolayer of Pt deposited onto a substrate comprised of Pd nanostructures. However, the metal overlayer is not limited to Pt, but may comprise any of a plurality of metals in which the surface Pt layer is alloyed with one or more transition metals which may include, but are not limited to iridium (Ir), osmium (Os), rhenium (Re), Ru, and/or Pd. Similarly, the nanostructured substrate is not limited to Pd, but may also comprise any of a plurality of transition metals such as Ir, Pt, Os, Re, or Ru either alone or as an alloy.

In still another embodiment, the nanostructured substrate is comprised of a non-noble metal such as nickel (Ni), cobalt (Co), or iron (Fe), a refractory metal such as titanium (Ti), tungsten (W), niobium (Nb), vanadium (Va) or tantalum (Ta), any of which may be used either alone or as an alloy. A shell comprising copper (Cu), Pd, gold (Au), Ru or another noble metal may be formed on the non-noble metal nanostructures by electroless deposition. The shell protects the non-noble metal core from corrosion during subsequent processing steps, including UPD of Cu and galvanic displacement by a more noble metal.

In another embodiment, the metal is not limited to a single monolayer of the metal or alloy, but may also be comprised of submonolayers or multilayers of the metal or alloy. A submonolayer may be obtained by incomplete surface coverages during electrodeposition whereas multilayers are obtained by repeating the cycle of depositing a non-noble metal followed by galvanic displacement by a more noble metal. Repeated cycles are also favored to ensure complete coverage of the underlying substrate by the metal overlayer.

In yet another embodiment, the nanostructured substrate is preferably comprised of nanorods, nanobars, and nanowires which are 2 to 100 nm in diameter and 10 to 1,000 nm in length. However, the nano structures are not so limited in terms of size and shape and may comprise any of a plurality of shapes and sizes as is well-known in the art. These include, but are not limited to nanostructures which are spherical, pyramidal, rod-shaped, cubic, tubular, cubooctahedral, and so forth. The thickness of the noble metal adlayer deposited onto the nanostructured substrate is preferably a submonolayer, monolayer, or bilayer.

An additional embodiment relates to the utilization of the metal/substrate nanostructures in the electrodes of an energy conversion device such as a fuel cell. The energy conversion device comprises at least a first electrode, a conducting electrolyte, and a second electrode. At least one of the first and second electrodes is comprised of electrocatalysts having a cylindrical transition metal core of diameter 2 to 100 nm and length of 10 to 1,000 nm. The transition metal core is coated with an atomic layer having a thickness selected from the group consisting of a submonolayer and monolayer of noble metal atoms. In a preferred embodiment, the transition metal core consists of Pd and the atomic layer consists of Pt. The Pt/Pd nanostructured electrodes are preferably used as the cathode in a fuel cell to accelerate ORR kinetics.

### BRIEF DESCRIPTION OF THE DRAWINGS

FIG. 1 shows a series of images illustrating the underpotential deposition of a Cu adlayer onto a Pd nanorod followed by the galvanic displacement of Cu atoms by Pt;

FIG. 2A is a transmission electron microscopy image showing an aggregate of Pd nanorods, each of which is covered with an atomically thin layer of Pt;

FIG. 2B is an enlarged transmission electron microscopy image of a typical Pd nanorod covered with an atomically thin layer of Pt;

FIG. 3A is a plot comparing the activity level of the oxygen reduction reaction for Pd nanoparticles and Pd nanorods;

FIG. 3B shows a plot of the activity level for the oxygen reduction reaction for Pd nanorods coated with a monolayer of Pt; and

FIG. 4 is a schematic showing the principles of operation of a fuel cell in which at least one electrode may be comprised of Pt/Pd nanorods.

### DETAILED DESCRIPTION OF THE INVENTION

These and other attributes of the invention will become more apparent from the following description and illustrative embodiment which are described in detail with reference to the accompanying drawing. In the interest of clarity, the following terms are defined as provided below:

### Acronyms

ALD: Atomic Layer Deposition
CVD: Chemical Vapor Deposition
FCC: Face Centered Cubic
MBE: Molecular Beam Epitaxy
ORR: Oxidation Reduction Reaction
PVP: Poly(Vinyl Pyrrolidone)
RHE: Reversible Hydrogen Electrode
TEM: Transmission Electron Microscopy
UPD: Underpotential Deposition

### DEFINITIONS

Adatom: An atom located on the surface of an underlying substrate.
Adlayer: A layer of atoms adsorbed to the surface of a substrate.
Bilayer: Two consecutive layers of atoms or molecules which occupy all available surface sites on each layer and coat the entire surface of the substrate.
Catalysis: A process by which the rate of a chemical reaction is increased by means of a substance (a catalyst) which is not itself consumed by the reaction.
Electrocatalysis: The process of catalyzing a half cell reaction at an electrode surface by means of a substance (an electrocatalyst) which is not itself consumed by the reaction.
Electrodeposition: Another term for electroplating.
Electroplating: The process of using an electrical current to reduce cations of a desired material from solution to coat a conductive substrate with a thin layer of the material.
Mesoporous: Containing pores with diameters between 2 and 50 nm.
Monolayer: A single layer of atoms or molecules which occupies available surface sites and covers the surface of the substrate.
Multilayer: More than one layer of atoms or molecules on the surface, with each layer being sequentially stacked on top of the preceding layer.
Nanocomposite: A material created by introducing a nanoparticulate filler material into a macroscopic sample material.
Nanostructure: Any manufactured structure with nanometer-scale dimensions.
Noble metal: Metals which are extremely stable and inert, being resistant to corrosion or oxidation. These generally comprise ruthenium (Ru), rhodium (Rh), palladium (Pd), silver (Ag), rhenium (Re), osmium (Os), iridium (Ir), platinum (Pt), and gold (Au). Noble metals are frequently used as a passivating layer.
Non-noble metal: A metal which is not a noble metal.
Redox reaction: A chemical reaction wherein an atom, or ion undergoes a change in oxidation number. This typically involves the loss of electrons by one entity accompanied by the gain of electrons by another entity.
Refractory metal: A class of metals with extraordinary resistance to heat and wear, but with generally poor resistance to oxidation and corrosion. These generally comprise tungsten (W), molybdenum (Mo), niobium (Nb), tantalum (Ta), and rhenium (Re).
Submonolayer: Surface atom or molecular coverages which are less than a monolayer.
Transition metal: Any element in the d-block of the periodic table which includes groups 3 to 12.

This specification describes a process for the deposition of a thin, contiguous layer of a metal onto a substrate comprising nanostructures possessing a high specific surface area that can yield a substrate with catalytic properties that are improved over those of either the metal or substrate alone. Since the catalytic behavior at a surface is proportional to the number of reaction sites, increasing the total surface area tends to increase the overall reaction rate. One approach to maximizing the overall surface area involves the formation of nanostructures such as nanorods, nanobars, and nanowires which increase the overall surface area by locating a higher fraction of atoms at a surface instead of within the bulk. Nanostructures shaped as nanorods, nanobars, and nanowires provide the added benefit of surface atoms which are positioned in configurations in which their reactivity is heightened.

### I. Nanostructure Synthesis

The nanostructures used in the present invention are not limited to being rod-shaped, but may take on any shape, size, and structure as is well-known in the art. This includes, but is not limited to spherical, branching, conical, pyramidal, cubical, mesh, fiber, cuboctahedral, and tubular nanostructures. The nanostructures may be agglomerated or dispersed, formed into ordered arrays, fabricated into an interconnected mesh structure, either formed on a supporting medium or suspended in a solution, and may have even or uneven size distributions. The nanostructures are preferably nanobars, nanorods, or nanowires on the order of 2 to 100 nm in diameter and 10 to 1,000 nm in length. However, the size is not so limited and may extend into the micrometer and millimeter size range.

Nanostructures have been formed from a wide variety of materials using a number of different techniques which involve both top-down and bottom-up approaches. Examples of the former include standard photolithography techniques, dip-pen nanolithography, and focused ion-beam etching. The latter comprises techniques such as electrodeposition or electroplating on templated substrates, laser ablation of a suitable target, vapor-liquid-solid growth of nanowires, and growth of surface nanostructures by sputtering, chemical vapor deposition (CVD) or molecular beam epitaxy (MBE) from suitable gas precursors and/or solid sources.

From among these, electrodeposition onto templated substrates has shown great promise due to its simplicity and low cost. It is to be understood that the terms electrodeposition and electroplating may be used interchangeably with each referring to the use of an electrochemical redox reaction to deposit a solid metallic composition onto a substrate from an aqueous or non-aqueous solution. The metallic composition itself may be deposited from a solution comprising a metal ion or a plurality of metal ions using methods well-known to those skilled in the art.

A. Electrodeposition onto Templated Surfaces

In one embodiment, direct electrodeposition of metal from an aqueous solution onto step edges on a vicinal single crystal surface is used. Growth is initiated by the preferential formation of a high density of nuclei along the length of the step edges. With continued growth the clusters eventually coalesce into hemicylindrical nanowires extending parallel to the step edges. The size, length, and spacing of the nanowires can be controlled by varying the number and proximity of step edges (thereby varying the number and position of nucleation sites) and the electrodeposition conditions.

Electroless deposition onto a stepped surface was reported by Z. Shi, et al. (hereinafter “Shi”) in “Synthesis of Palladium Nanostructures by Spontaneous Electroless Deposition,” Chem. Phys. Lett., 422, 147 (2006), the entire contents of which is incorporated by reference as if fully set forth in this specification. Shi demonstrated the spontaneous formation of arrays of Pd nanostructures on the surface of a 0.2-μm grade porous 316L stainless steel plate which was immersed in a Pd electroless plating bath. The resulting Pd nanostructures preferentially nucleate as small clusters at surface perturbations such as step edges, thereby forming beaded linear arrays. Continued deposition results in coalescence of the clusters into individual Pd nanowires which are 80 to 130 nm in diameter.

In another embodiment, stacked arrays of long, dimensionally uniform nanowires may be formed by the selective electrodeposition of a metal at step edges on a stepped surface such as highly ordered pyrolytic graphite (HOPG). This is described, for example, in U.S. Patent Appl. No. 2008/0128,284 to Penner, et al. (hereinafter “Penner”) which is incorporated by reference as if fully set forth in this specification. Penner discloses the selective electrodeposition of Pd onto a stepped graphite surface which is exposed to an aqueous plating solution comprising Pd ions in concentrations ranging from 1×10⁻³ to 1×10^{˜}2 M. Pd nucleation is promoted by application of an initial rapid nucleation pulse prior to electrodeposition at the desired overpotential. Deposition is then preferably carried out at a low, essentially constant deposition current.

In one example, Penner discloses that a freshly cleaved graphite surface is immersed within a Pd plating solution which may comprise 2.0 mM Pd²⁺, 0.1 M HCl, and water or 2.0 mM Pd²⁺, 0.1 M HClO₄, and water. An initial 5 ms nucleation pulse at −0.2 V is followed by deposition at a low, nearly constant deposition current which is preferably less than 50 mA/cm². The final diameter, length, and structure of the resulting nanowires is dependent on the plating conditions, including the type of electrolyte and deposition time. For example, Pd nanowires formed in HCl solutions tend to be rough and granular whereas HClO₄ solutions yield nanowires with a smoother surface. The diameter of the Pd nanowires may range from 10 to 15 nm up to 1.0 μm with lengths of 10 to 20 μm, but preferably several hundred microns in length. The desired size, placement, structure, and surface coverage may be obtained by using the appropriate deposition conditions.

B. Electrodeposition within a Mesoporous Template

In yet another embodiment metal nanostructures may be formed by electrodepositing a metal into the pores of a mesoporous silica template to form a metal-containing silica nanocomposite. This is described, for example, in U.S. Pat. No. 7,001,669 to Lu, et al. (hereinafter “Lu”) the entire contents of which is incorporated by reference as if fully set forth in this specification. In one embodiment Lu discloses the formation of a mesoporous silica template onto a substrate of an electrically conductive material. The substrate may be a metal such as aluminum or copper or a conductive film deposited on a nonconducting substrate such as a glass or polymeric material with a metal coating. The mesoporous silica itself is preferably a porous silica material having pore sizes ranging from 0.8 to 20 nm with a thickness ranging from 50 to 1,000 nm.

The mesoporous silica used to form a template may be prepared using any method as is well-known in the art. Such methods are described, for example, in U.S. Pat. No. 5,858,457 to Brinker, et al. which is incorporated by reference as if fully set forth in this specification. The template itself is not limited to silica, but may be alumina, polycarbonate membranes, organic block copolymers, or any other material with a similar pore structure and which is compatible with the electrodeposition process. Typical mesoporous silicas include hexagonal, swirled, and cubic mesoporous silica. A hexagonal mesoporous silica template is comprised of essentially cylindrical pores of uniform diameter which are stacked into a one-dimensional array. Cubic and swirled mesoporous silica templates comprise a three-dimensional pore structure having substantially interconnecting pores with the latter comprising curled and nested tubular pores.

In a preferred embodiment, a hexagonal mesoporous silica template resembling stacked pipes is formed on a conducting substrate. The resulting template is 200 to 500 nm thick with pore dimensions (e.g., the resulting nanowire diameter) of approximately 5 to 9 nm. The substrate plus template assembly is immersed in a 0.5 weight % solution of PdCl₂ in aqueous HCl of about 1 N. Electrodeposition was performed by using the conductive surface of the mesoporous silica template as the working electrode, platinum wire as a counter-electrode, and a standard Ag/AgCl reference electrode. Application of a voltage difference across a circuit comprising the aforementioned three electrodes results in electrodeposition of Pd within the pores of the template to form a Pd-silica nanocomposite. The current density was maintained at approximately 20 mA/cm² for the desired time interval which preferably is about 10 to 30 min.

The nanocomposite is subsequently annealed at a temperature which is no more than 40% of the melting temperature of the metal for a time period sufficient to make the metallic nanostructured film self-supporting. For Pd this involves annealing the nanocomposite-coated substrate at 400° C. for two hours and cooling in an atmosphere of either nitrogen or forming gas (˜1% hydrogen in nitrogen gas). Removal of the template may be accomplished by any method which maintains the integrity of the metal nanowires, yet completely removes the template. In a preferred embodiment the mesoporous silica template is removed by soaking in a solution of dilute aqueous HF acid (about 0.1 to 10 wt. %) for one minute followed by rinsing in deionized water. Once the silica is completely removed a nanowire film with a thickness ranging from 50 to 1,000 nm and individual nanowire diameters of 2 to 20 nm is attained. The nanowire diameter is more preferably in the range of 3 to 10 nm. The final film thickness and nanowire diameter may be controlled, for example, by varying the pore size within the mesoporous silica template.

### C. Solution-Phase Growth of Nanostructures

In still another embodiment, high-quality single-crystal Pd nanostructures may be synthesized by solution-phase growth. Template-directed synthesis of Pd nanostructures is generally limited to the production of a relatively small number of polycrystalline nanostructures. On the other hand, solution-phase growth is capable of producing a large number of high quality single crystal Pd nanostructures. Since Pd has a face-centered cubic (FCC) crystal structure it is not thermodynamically favorable for anisotropic Pd structures to form from seed crystals in an isotropic medium. Consequently, the formation of Pd nanostructure by solution-phase growth must be kinetically driven.

The controlled growth of highly anisotropic single-crystal Pd nanobars and nanorods as well as twinned nanorods and right bipyramids by solution-phase growth has been demonstrated by Xiong, et al. (hereinafter “Xiong”). This is described, for example, in “Synthesis and Mechanistic Study of Palladium Nanobars and Nanorods,” J. Chem. Soc. 129, 3665 (2007) and “Synthesis and Characterization of Fivefold Twinned Nanorods and Right Bipyramids of Palladium,” Chem. Phys. Lett. 440, 273 (2007) the entire contents of all of which are incorporated by reference as if fully set forth herein. In one embodiment, Xiong demonstrated that the introduction of bromide (Br) to the reaction solution alters surface free energies of the Pd seed crystal, thereby promoting preferential growth along specific crystallographic planes. By adjusting the experimental conditions, selective growth of Pd nanostructures with differing geometrical shapes may be formed.

In one embodiment, Xiong demonstrates the growth of Pd nanobars which are cubical structures enclosed by {100} facets and nanorods which possess an octagonal cross-section with side surfaces bound by a mix of {100} and {110} facets. Typical Pd nanostructure synthesis proceeds by initially heating a flask containing 5 ml of ethylene glycol to 100° C. in air. A mixture comprising 0.0486 g of Na₂PdCl₄ and 0.600 g of KBr was dissolved in 3 ml of water and another mixture comprising 0.0916 g of poly(vinyl pyrrolidone) (PVP) dissolved in 3 ml of ethylene glycol were separately prepared. The two solutions, which were prepared with the molar ratio of PdCl₄²⁻ to Br— to the repeating unit of PVP being 1:30:15, were then simultaneously injected into the flask using a two-channel syringe pump at a rate of 45 ml/h. The reaction mixture was heated to 100° C. in air for one hour and subsequently collected by centrifugation. The resulting Pd nanostructures were washed with acetone and ethanol to remove ethylene glycol and excess PVP.

The formation of Pd nanostructures occurs via the co-reduction of Na₂PdCl₄ by ethylene glycol and PVP. While PVP has been shown to be a mild reducing agent, ethylene glycol is a stronger agent for the reduction of metal salts. By varying the temperature and concentration of water, PVP, and ethylene glycol, well-defined nanostructures, nanobars, and nanorods with various aspect ratios can be formed. Thus, higher ethylene glycol concentrations and higher temperatures favor the formation of more anisotropic Pd nanostructures. Reduction rates generally classified as slow, medium, and fast resulted in Pd nanobars with a width of 8 nm, aspect ratio of 1-1.2, nanobars with a width of 6 nm, aspect ratio of 2-4, and nanorods with a diameter of 2 nm and aspect ratio of 8, respectively. Increasing the reaction temperature from 100 to 120° C. doubled the aspect ratio from 8 to 16 while maintaining a diameter of 2 nm.

Solution-phase growth is not limited to Pd, but may also be achieved using other transition metals such as gold (Au) and Pt. Nanostructures with the desired shape, dimensions, and overall size distribution may be synthesized by adjusting the solution chemistry and reaction conditions. The Pd nanostructures so-obtained may be subsequently collected and deposited on a suitable substrate.

### D. Core-Shell Nanostructures

In still another embodiment, the nanostructured substrate may take the form of a non-noble transition metal core which is covered with a thin film of a noble metal. The noble metal shell is necessary to protect the underlying non-noble core from corrosion during exposure to the acid-based electrolytes used in subsequent processing steps and to enable UPD of the intermediary metal (e.g., Cu) during subsequent Pt film growth as detailed in Section II below. The combination of core and shell metals used may also be suitably selected to enhance the catalytic properties of the Pt monolayer. This enhancement may be accomplished by electronic effects and/or by adjusting the lattice parameter of the surface shell to induce strain in the Pt overlayer such that its catalytic activity increases.

Core-shell nanoparticles may be formed, for example, using processes described by J. Zhang, et al. in “Platinum Monolayer on Nonnoble Metal-Noble Metal Core-Shell Nanoparticle Electrocatalysts for O₂ Reduction,” J. Phys. Chem. B. 105, 22 701 (2005) and U.S. Patent Appl. No. 2006/0135,359 the entire contents of all of which is incorporated by reference as if fully set forth in this specification. Initially, a nanostructured substrate comprised of a non-noble metal such as nickel (Ni), cobalt (Co), or iron (Fe), or a refractory metal such as titanium (Ti), tungsten (W), niobium (Nb), or tantalum (Ta) is formed. These metals may be used either alone or as an alloy.

In an illustrative embodiment, a core-shell system may be formed from nanostructures comprising, for example, Ni—Au, Co—Pd, or Co—Pt alloys. Subsequent annealing of nanostructures formed of these alloys results in surface segregation of the noble metal (e.g., Au, Pd, or Pt), thereby forming the desired core-shell nanoparticle. In another embodiment a nanostructured core of a non-noble metal may initially be formed using any of the processes detailed in Sections A-C above. The non-noble metal core is not limited to Ni, Co, or Fe, but also may be a refractory metal. This core may then be covered with a thin shell of Cu, Pd, Au, Ru or another noble metal by a suitable process such as electroless deposition or by chemical routes such as atomic layer deposition (ALD) or CVD.

It is to be understood that the methods of forming the nanostructures as described above are merely exemplary. As previously indicated, a plurality of alternate methods may be employed. In addition, the electrodeposited metal is not limited to Pd, Pd alloys, or transition metal core-shell nanostructures and the substrate is not limited to those described above. The nanostructures may be fabricated of any other suitable transition metal which is deposited on a substrate having an electrically conductive surface. Any of the deposition processes described above may be used to form a nanostructured metal film on a conducting substrate.

The nanostructures themselves are preferentially nanobars, nanorods, and nanowires with diameters ranging from 2 to 100 nm and lengths of 10 to 1,000 nm. The desired thickness, structure, and size range may be obtained via suitable adjustment of the processing parameters. Bar or rod-shaped nanostructures have increased surface reactivity since their cylindrical shape and nanometer-scale diameters result in surface atoms which are highly coordinated. The bonding configuration of these surface atoms is such that their reactivity and, hence, their ability to function as a catalyst is increased.

### II. Deposition of a Thin Metal Film

Nanostructure formation is followed by the deposition of a metal overlayer having thicknesses in the submonolayer-to-multilayer range. For the purposes of this specification, a monolayer is formed when the surface of a material is fully covered by a single layer comprising adatoms of material which usually form a chemical or physical bond with the surface of the first (substrate) material. A monolayer is formed when substantially all available surface sites are occupied by an adatom of material. If the surface of the substrate is not completely covered by the adsorbed material, then the film coverage is submonolayer. However, if additional layers of material are deposited onto the first layer, then multilayer coverages result.

In addition to electroplating, a wide variety of thin film deposition processes are well-known in the art. These include, but are not limited to, thermal evaporation, CVD, MBE, pulsed laser deposition, sputtering, and ALD. Many of these techniques require specialized equipment capable of attaining medium to ultrahigh vacuum conditions and providing precise control over the impinging flux of atoms. Electrodeposition, on the other hand, is a robust, relatively low-cost deposition technique capable of controllably depositing thin films with thicknesses ranging from submonolayer coverages up to several microns. Electrodeposition may be carried out in aqueous or nonaqueous solutions as well as solutions comprising an ionic liquid.

A synthetic procedure which employs the principles of electrodeposition and galvanic displacement has been utilized by Brankovic, et al. (hereinafter “Brankovic”) to deposit a monolayer of Pt onto Au(111) substrates and by Adzic, et al. (hereinafter “Adzic”) to deposit Pt monolayers onto Pd(111) and carbon-supported Pd nanoparticles. The procedures are described, for example, in “Metal Monolayer Deposition by Replacement of Metal Adlayers on Electrode Surfaces,” Surf. Sci., 474, L173 (2001) and U.S. Patent Appl. No. 2006/0135,359, respectively, each of which is incorporated by reference as if fully set forth in this specification.

The deposition process is centered around a series of electrochemical reactions which, when performed sequentially, result in a film with the targeted coverage and composition. The procedure involves the initial formation of an adlayer of a metal onto a substrate by underpotential deposition (UPD). This is followed by the galvanic displacement of the adsorbed metal by a more noble metal, resulting in the conformal deposition of a monolayer of the more noble metal on the substrate. The overall process involves the irreversible and spontaneous redox displacement of an adlayer of a non-noble metal by a more noble metal. This enables the controlled deposition of a thin, continuous layer of a desired metal. The process requires that the substrate metal be more noble than the metal being deposited in order to avoid becoming oxidized. The redox reaction can be described by the following equation

M_{UPD}⁰+(m/z)NM^{z+} [symbol] M^{m+}+(m/z)NM⁰ (1)

where M_{UPD}⁰ represents a UPD metal adatom on the electrode surface and NM^{z+} is a noble metal cation with positive charge z+ and valence z. The M^{m+} represents the metal cation in the solution obtained after the UPD adatom was oxidized, and NM⁰ is a noble atom deposited in the redox process.

The deposition of a monolayer of Pt onto Pd nanostructures which are preferentially nanobars, nanorods, and nanowires using the processes described by Brankovic and Adzic will now be described in detail. The method involves the initial formation of a monolayer of a metal such as copper (Cu) by underpotential deposition in a solution comprised of 50 mM CuSO₄ in 0.1 M H₂SO₄. The Cu-coated nanostructured Pd substrate is then emersed from the solution and rinsed with deionized water to remove Cu²⁺ ions from the surface. This is followed by immersion in a solution comprised of 1.0 mM K₂PtCl₄ in 50 mM H₂SO₄ under an N₂ atmosphere for approximately two minutes to replace all Cu atoms with Pt atoms. The Pt-coated nanostructured Pd substrate is again rinsed with deionized water. The above processes were carried out in a multi-compartment cell under a N₂ atmosphere in order to prevent Cu oxidation by O₂ during sample transfer.

The above process results in the conformal deposition of a monolayer of Pt on high-surface-area Pd nanostructures, preferably nanobars, nanorods, and nanowires (e.g., Pt/Pd nanostructures). The deposition cycle comprising UPD of Cu followed by galvanic displacement with Pt may be repeated as needed to produce two or more layers of Pt in order to ensure complete coverage of the Pd surface. Conversely, the UPD of Cu may be controllably limited such that submonolayer coverages of Cu and, hence, Pt are obtained. The metal overlayer used is not limited to Pt, but may be formed from other metals with the only requirement being that the desired metal be more noble than the UPD adlayer. Furthermore, the metal overlayer may be formed as an alloy with any number of constituents such as binary, ternary, quaternary, or quinary alloys with experimentally optimized stoichiometry ratios. The same principle applies to the nanostructures used as the substrate in that the nanostructures may be fabricated from various combinations of metals to form an alloy. Examples of other metals include, but are not limited to Ir, Os, Re, Ru, and/or Pd. The nanostructures may also be core-shell nanostructures fabricated from a non-noble transition metal core and a noble metal shell layer.

The process offers precise control over film growth and is advantageous in terms of its versatility, reproducibility, and efficient utilization of source material. Since a costly precious metal such as Pt can be utilized as a submonolayer-to-multilayer thin film instead of in bulk form, significant cost savings may be attained. The utilization of a metal/substrate or, more specifically, a Pt/Pd nanostructure also provides unexpectedly heightened catalytic activity. In fact, due to synergistic effects, the catalytic activity is greater than either bulk Pt or Pd alone. The unexpected increase in interactions between O₂ and Pt/Pd nanostructures which are preferably nanobars, nanorods, or nanowires appears to be influenced by electronic and geometric effects which arise from the formation of surface metal-metal bonds and the differing lattice constants of Pd and Pt, respectively.

The catalytic properties of the Pt overlayer may also be engineered by use of a suitable core-shell nanostructure. A nanostructured core of a non-noble metal such as Ni, Co, Fe, Ti, W, Nb, or Ta may be coated with a more noble metal such as Au, Pd, or Pt. The catalytic activity of the final Pt-coated nanostructure may be controlled by engineering the electronic properties and lattice parameter of the underlying core-shell nanostructures.

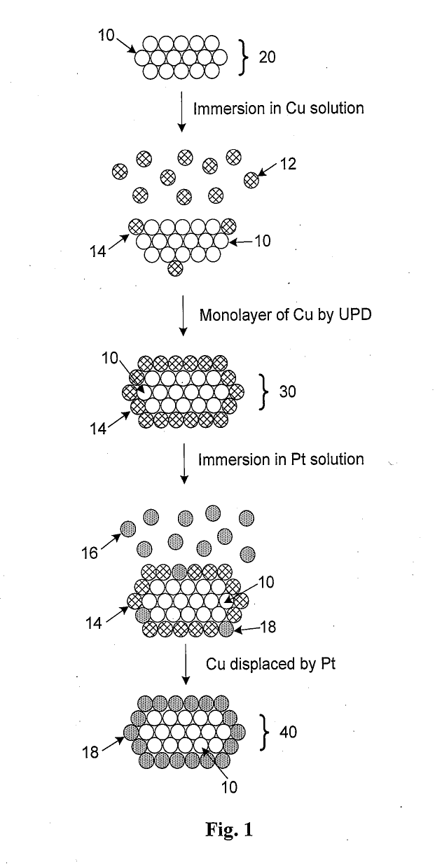

An embodiment describing a method of forming Pt/Pd nanostructures will now be described in detail with reference to FIG. 1. The embodiment is merely exemplary and is used to describe the best mode of practicing the invention. It is to be understood that there are many possible variations which do not deviate from the spirit and scope of the present invention.

### III. Exemplary Embodiments

An exemplary embodiment of the present invention will now be described in detail with reference to FIGS. 1-3. FIG. 1 shows a sequence of surface chemical reactions culminating in the formation of a Pt/Pd nanorod. The desired Pd nanostructures, which are preferably nanobars, nanorods, and nanowires are initially formed using any of the plurality of methods previously described. For the purposes of this description, a single Pd nanorod (20) comprised of individual Pd atoms (10) is illustrated in FIG. 1. The Pd nanorod (20) is initially immersed in a plating bath comprising the appropriate concentration of Cu²⁺ ions (12). UPD of Cu results in the formation of a monolayer of Cu (14) on the surface of the Pd nanorod. This monolayer forms a continuous “skin” around the periphery of the Cu/Pd nanostructure (30).

The nanorod is them emersed from the bath and rinsed with deionized water to remove excess Cu²⁺ (12) ions on the surface. The sample is maintained under a N₂ atmosphere during transfer to inhibit oxidation of the freshly deposited Cu adlayer (14). The nanorod is then immersed in a solution a Pt salt where Pt²⁺ ions (16) replace surface Cu adatoms (14) via a redox reaction. Since Pt is more noble than Cu, it acts as an oxidizing agent by accepting electrons from Cu. The simultaneous reduction of Pt²⁺ ions to Pt (18) results in the replacement of surface Cu atoms with Pt atoms (18). The final product is a Pt/Pd nanorod with a “skin” comprising a monolayer of Pt atoms (40).

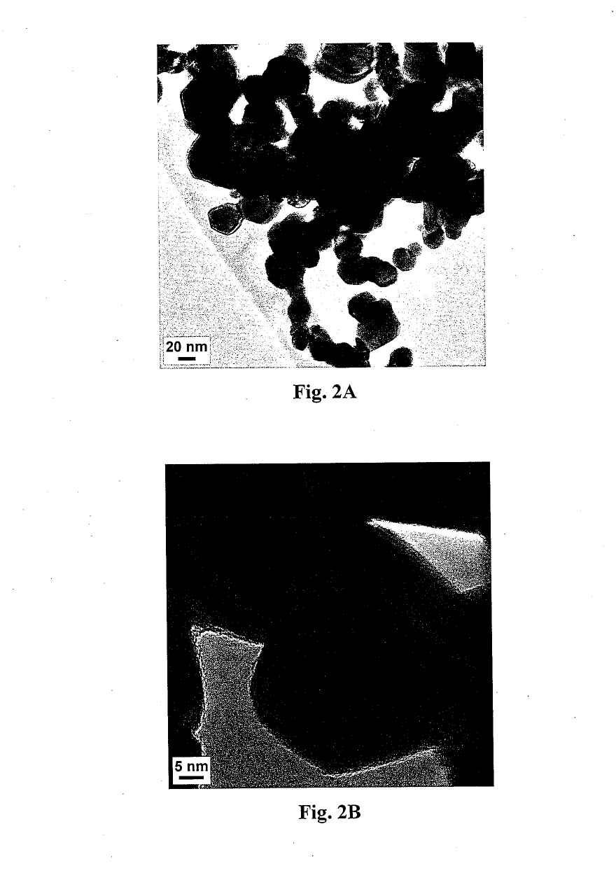

The cycle depicted in FIG. 1 may be repeated any number of times to deposit additional layers of Pt onto the surface of the Pd nanorods to ensure complete coverage. Conversely, less than a monolayer of Cu may be deposited during UPD such that submonolayer coverages of Pt result. The “skin” of Pt atoms will form a continuous conformal coverage across the entire available smooth surface area. A transmission electron microscopy (TEM) image showing a plurality of Pt-coated Pd nanorods formed using the process described above is provided in FIG. 2A. An enlarged TEM image which shows a close-up of individual nanorods is provided in FIG. 2B.

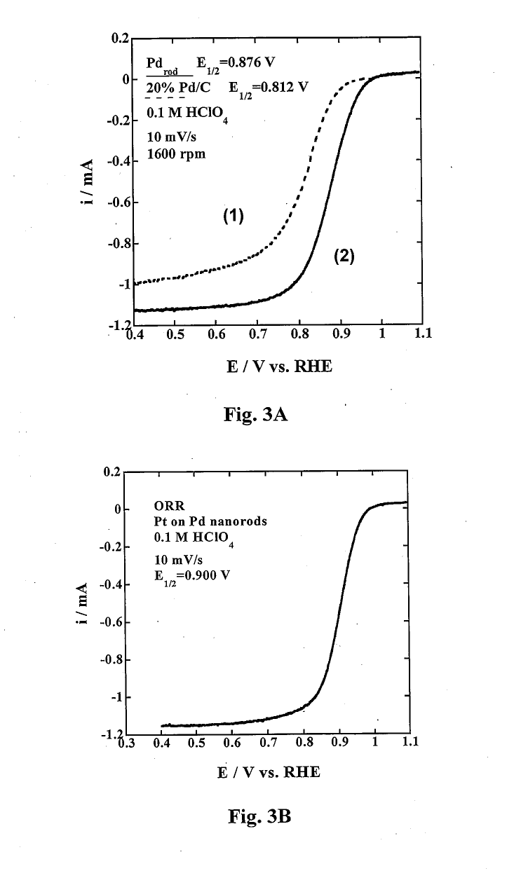

The ORR activity for Pd nanoparticles as well as Pd and Pt-coated Pd nanorods was measured using the rotating disc electrode technique and the results are provided in FIGS. 3A and 3B. Measurements were obtained in a solution of 0.1 M HClO₄ at a sweep rate of 10 milliVolts per second (mV/s) and a rotation speed of 1600 rotations per minute (rpm). In FIGS. 3A and 3B the current in milliamps per square centimeter (mA/cm²) is provided on the vertical or y-axis whereas the applied potential in volts (V) is shown on the horizontal or x-axis. A Pt wire was used as the counter electrode and a Ag/AgCl/(3 M NaCl) electrode was used as the reference electrode. All reported potentials have been referenced to the reversible hydrogen electrode (RHE).

FIG. 3A is a plot showing the half-wave potential (E_{1/2}) for carbon-supported Pd (Pd/C) nanoparticles (curve 1) and Pd nanorods (curve 2). The results show that for Pd/C nanoparticles E_{1/2}=0.812 V whereas for Pd nanorods there is a positive shift in the half-wave potential to E_{1/2}=0.876 V. The 0.064 V increase in E_{1/2} could be due to geometric effects in which a change in the local coordination and bonding configuration of surface atoms creates an increase in the surface reactivity. After depositing a monolayer of Pt on the Pd nanorods it was possible to obtain still further increases in E_{1/2}. This is illustrated by FIG. 3B which shows that the half-wave potential for Pt/Pd nanorods is E_{1/2}=0.900 V. This represents an increase of 0.024 V over the activity of Pd nanorods.

In a preferred application, the Pt/Pd nanostructures which are preferably nanobars, nanorods, and nanowires as described above may be used as the cathode in a fuel cell. This application is, however, merely exemplary and is being used to describe a possible implementation of the present invention. Implementation as a fuel cell cathode is described, for example, in U.S. Patent Appl. No. 2006/0135,359 to Adzic which is incorporated by reference as if fully set forth in this specification. It is to be understood that there are many possible applications which may include, but are not limited to H₂ sensors, charge storage devices, applications which involve corrosive processes, as well as various other types of electrochemical or catalytic devices.

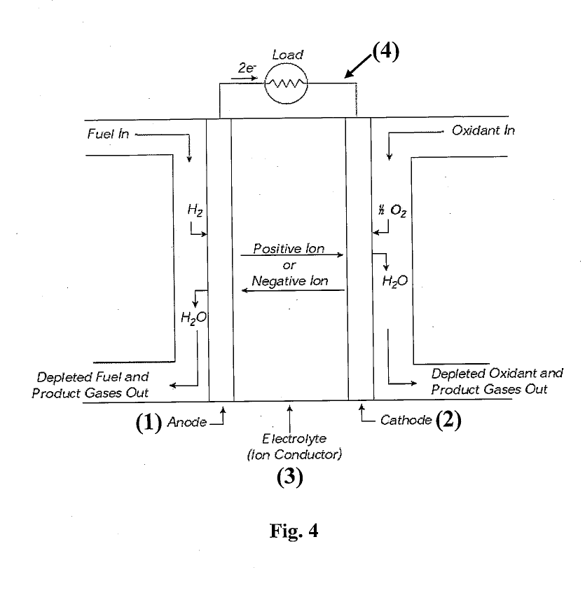

A schematic showing an example of a fuel cell and its operation is provided in FIG. 4. A fuel such as hydrogen gas (H₂) is introduced through a first electrode (1) whereas an oxidant such as oxygen (O₂) is introduced through the second electrode (2). In the configuration shown in FIG. 4, the first electrode (1) is the anode and the second electrode (2) is the cathode. At least one electrode is comprised of nanorods, nanobars, or nanowires which, in a preferred embodiment, have a Pd nanorod core coated with an atomically thin layer of Pt. Under standard operating conditions electrons and ions are separated from the fuel at the anode (1) such that the electrons are transported through an external circuit (4) and the ions pass through an electrolyte (3). At the cathode (2) the electrons and ions combine with the oxidant to form a waste product which, in this case, is H₂O. The electrical current flowing through the external circuit (4) can be used as electrical energy to power conventional electronic devices. The increase in the ORR rate attainable through incorporation of Pt/Pd nanorods in one or more electrodes will produce an increase in the overall energy conversion efficiency of the fuel cell. Consequently, for a given quantity of fuel, a larger amount of electrical energy will be produced when using Pt/Pd nanorod-based electrodes compared to conventional nanoparticle electrodes.

It will be appreciated by persons skilled in the art that the present invention is not limited to what has been particularly shown and described hereinabove. Rather, the scope of the present invention is defined by the claims which follow. It should further be understood that the above description is only representative of illustrative examples of embodiments. For the reader's convenience, the above description has focused on a representative sample of possible embodiments, a sample that teaches the principles of the present invention. Other embodiments may result from a different combination of portions of different embodiments. Furthermore, the specification has not attempted to exhaustively enumerate all possible variations. It will be appreciated that many of those undescribed embodiments are within the literal scope of the following claims, and others are equivalent. All references, publications, U.S. patents, and U.S. patent Publications cited throughout this specification are incorporated by reference as if fully set forth in this specification.

1. An electrocatalyst comprising a cylindrical nanostructured core of a transition metal coated with a contiguous atomic layer of noble metal atoms.

2. The electrocatalyst of claim 1, wherein the cylindrical nanostructured core is a bar, rod, or wire.

3. The electrocatalyst of claim 2, wherein the cylindrical nanostructured core has a diameter of 2 to 100 nm and a length of 10 to 1,000 nm.

4. The electrocatalyst of claim 1 wherein the cylindrical nanostructured core consists of Pd.

5. The electrocatalyst of claim 1 wherein the atomic layer consists of Pt.

6. The electrocatalyst of claim 1 wherein the contiguous atomic layer coating is selected from the group consisting of a submonolayer, monolayer, and bilayer.

7. The electrocatalyst of claim 1 wherein the cylindrical nanostructured core comprises a non-noble metal core covered with a noble metal core shell and wherein the non-noble metal core is selected from the group consisting of Ni, Co, Fe, and a refractory metal.

8. The electrocatalyst of claim 7 wherein the refractory metal is Ti, Ta, Nb, or W.

9. The electrocatalyst of claim 7 wherein the noble metal core shell comprises Pd, Au, Re, Ir, or Ru.

10. A method of forming an electrocatalyst comprising a cylindrical nanostructured core of a transition metal coated with a contiguous atomic layer of noble metal atoms comprising:
fabricating a plurality of cylindrical nanostructured cores of a transition metal;
forming a continuous non-noble metal adlayer having a submonolayer or monolayer thickness on a surface of the cylindrical nanostructured cores; and
immersing the cylindrical nanostructured cores in a solution comprising a noble metal salt.

11. The method of claim 10, wherein the cylindrical nanostructured core is a bar, rod, or wire.

12. The method of claim 10 wherein the cylindrical nanostructured core has a diameter of 2 to 100 nm and a length of 10 to 1,000 nm.

13. The method of claim 10, wherein the transition metal consists of Pd, the non-noble metal adlayer consists of Cu, and the noble metal salt consists of Pt.

14. The method of claim 10 wherein the transition metal is Pd.

15. The method of claim 10 wherein the noble metal salt is Pt.

16. An energy conversion device comprising:
a first electrode,
a conducting electrolyte; and
a second electrode,
wherein at least one of the first and second electrodes is comprised of electrocatalysts having a cylindrical nanostructured core consisting of a transition metal having a diameter of 2 to 100 nm and a length of 10 to 1,000 nm coated with an atomic layer having a thickness selected from the group consisting of a submonolayer and monolayer of noble metal atoms.

17. The energy conversion device of claim 16, wherein the transition metal consists of Pd and the atomic layer consists of Pt.

18. An electrocatalyst comprising:
a cylindrical nanostructured core consisting of a transition metal having a diameter of 2 to 100 nm and a length of 10 to 1,000 nm; and
a surface coating having a thickness selected from the group consisting of a submonolayer and monolayer of noble metal atoms.

19. The electrocatalyst of claim 18, wherein the transition metal consists of Pd.

20. The electrocatalyst of claim 18, wherein the noble metal atoms consist of Pt.
